(19) United States
(12) Patent Application Publication
(10) Pub. No.: US 2017/0255357 A1
(43) Pub. Date: Sep. 7, 2017

(54) DISPLAY CONTROL DEVICE

(71) Applicant: KYOCERA Document Solutions Inc., Osaka (JP)

(72) Inventor: Isaac JUDD, Osaka (JP)

(21) Appl. No.: 15/446,019

(22) Filed: Mar. 1, 2017

(30) Foreign Application Priority Data
Mar. 3, 2016 (JP) 2016-040547

(51) Int. Cl. G06F 3/0486; G06F 3/0482; G06F 3/0481

(52) U.S. Cl. CPC G06F 3/0486; G06F 3/04817; G06F 3/0482; G06F 2203/04803

(57) ABSTRACT

A display control device performs control operations so that an icon that starts an application installed in a computer is displayed on a display screen. The display control device includes an icon combining unit and a display control unit. The icon combining unit combines a plurality of icons to create a combined icon that allows a plurality of applications to start with a single operation. The display control unit performs control operations so that the combined icon created by the icon combining unit is displayed on the display screen.

### INCORPORATION BY REFERENCE

The disclosure of Japanese Patent Application No. 2016-040547 filed on Mar. 3, 2016 including the specification, drawings and abstract is incorporated herein by reference in its entirety.

### BACKGROUND

The present disclosure relates to a display control device.

Displays, which are connected to a computer and serves as an interface with users, shows information submitted from the computer and descriptions input by the user. The displays have a display screen on which icons and toolbars are displayed that allow users to start applications and open files and folders with a click. Clicking an icon opens a window to start an application or to open a file or a folder.

There are some well-known techniques of displaying icons.

A typical information processing system includes a display device capable of displaying a plurality of icons, and an input device including a pointing device, and is provided with a graphical user interface allowing users to drag and drop a first icon on a second icon displayed on the display screen with the pointing device to perform information processing associated with the first and second icons. A feature of the information processing system is that, prior to performing information processing by dropping the first icon on the second icon, the user can set up processing conditions for the information processing by performing a specified operation while the input device keeps dragging the first icon in the vicinity of the second icon.

According to a typical multifunction device, in response to detecting that a first input meets predefined folder-creation criteria while a first object is proximate to a second object, the device creates a folder that contains the first object and the second object.

According to a typical folder management device, a contact with a touch sensitive screen at a location that corresponds to a location where a first operation icon is present on a display, and a subsequent movement of the contact to a location near a second operation icon, are regarded as an input. In response to the input, the device creates a new folder including a reduced scale representation of a first selectable user-interface object and a second selectable user-interface object, and displays an icon of the new folder.

### SUMMARY

The display control device of this disclosure performs control operations to display on a display screen an icon that starts an application installed in electronic equipment. The display control device includes an icon combining unit and a display control unit. The icon combining unit combines a plurality of icons to create a combined icon that allows a plurality of applications to start with a single click. The display control unit performs control so that the combined icon created by the icon combining unit is displayed on the display screen.

### BRIEF DESCRIPTION OF THE DRAWINGS

FIG. 1 is a block diagram showing the configuration of a display system including a display control device according to an embodiment of the disclosure.

FIG. 2 is an external view of a computer including the display control device shown in FIG. 1.

FIG. 3 illustrates an example of a combined icon created by an icon combining unit.

FIG. 4 illustrates an example of a display screen on which icons are displayed.

FIG. 5 illustrates an example of a combined icon created by the icon combining unit.

FIG. 6 illustrates an example of a combined icon created by the icon combining unit.

FIG. 7 illustrates an example of a combined icon created by the icon combining unit.

FIG. 8 illustrates an example of a combined icon created by the icon combining unit.

FIG. 9 is a block diagram showing the configuration of a portable terminal device including the display control device according to the disclosure.

### DETAILED DESCRIPTION

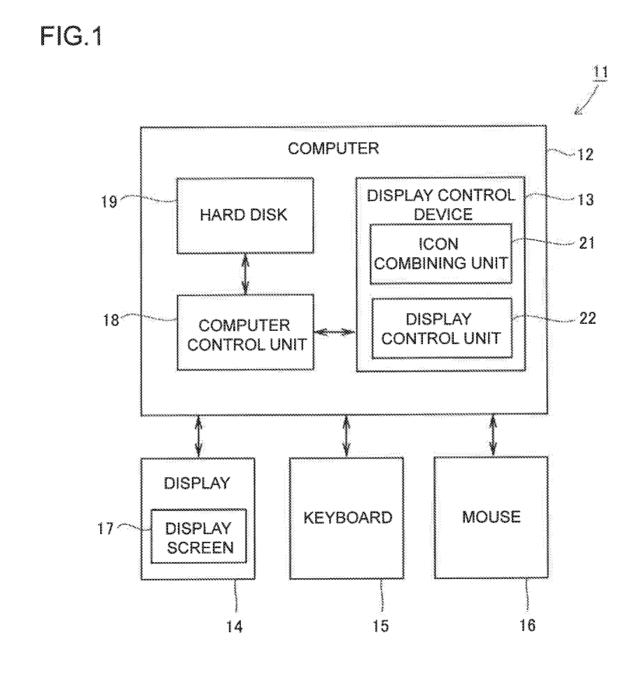

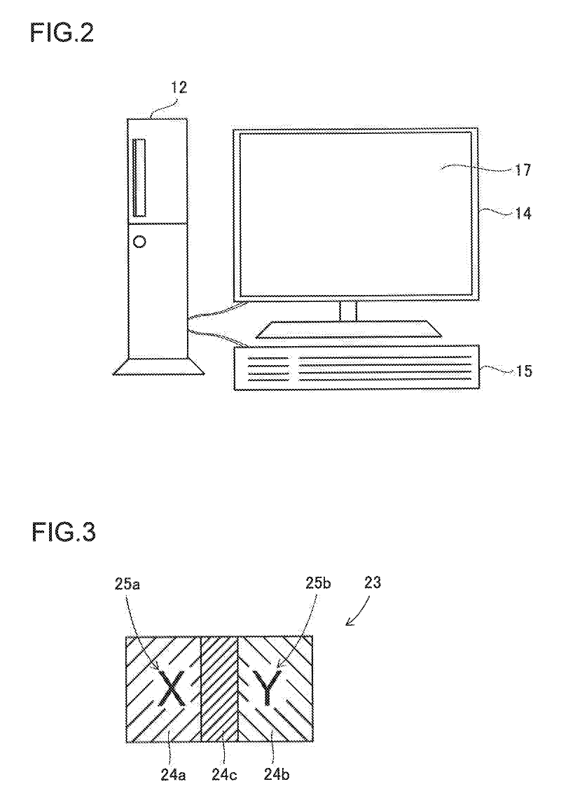

An embodiment of the present disclosure will be described below. FIG. 1 is a block diagram showing the configuration of a display system including a display control device according to the embodiment of the disclosure. FIG. 2 is an external view of a computer, which is electronic equipment, including the display control device shown in FIG. 1.

Referring to FIGS. 1 and 2, a display system 11 includes a computer 12, as electronic equipment, having a display control device 13, a display 14 having a display screen 17, a keyboard 15, and a mouse 16. The computer 12 is connected to the display 14, keyboard 15, and mouse 16.

The computer 12 includes a computer control unit 18 that controls the computer 12 itself, and a storage unit, for example, a hard disk 19 that stores data. The computer control unit 18 is composed of a control circuit, such as a central processing unit (CPU). The computer control unit 18 executes control programs stored in the hard disk 19 to control the operations of components of the computer 11. Various applications are installed in the hard disk 19. The display 14 functions as an output interface to a user when the computer 12 displays information on the display 14. Specifically, the display 14 displays on the display screen 17 various kinds of information of the computer 12 as well as descriptions input by users. More specifically, the display screen 17 shows icons, toolbars and other pictograms that start applications or open files or folders with a click, which is a specified operation. If a touch panel is used as the interface with users, the specified operation includes touching the touch panel. For example, if a touch panel is provided to an image-forming multifunction peripheral to serve as an interface through which operational descriptions are input, the specified operation includes touching icons and menus on the touch panel. In addition, if the touch panel is a capacitive touch panel, users can operate the touch panel without directly touching the screen.

The keyboard 15 and mouse 16 are input interfaces from users to the computer 12. Specifically, users see the descriptions displayed on the display screen 17 of the display 14, and manipulate the keyboard 15 and mouse 16 to perform operations such as inputting commands to execute them and inputting numerical data to the computer 12.

The display control device 13, which controls the display of the display screen 17, is provided in the computer 12, and is controlled by the computer control unit 18. The display control device 13 performs control operations to display an icon that starts an application, which has been installed in the computer 12, with a click, which is a pressing operation regarded as an example of the specified operations, on the display screen 17.

The display control device 13 includes an icon combining unit 21 and a display control unit 22. The icon combining unit 21 combines a plurality of icons into a combined icon that allows a plurality of applications to start with a single click. For example, the combination of two icons is made by dragging and dropping one icon onto the other. Alternatively, the icons can be combined on a setting screen that is provided only for combining icons. The display control unit 22 performs control operations so that the combined icon created by the icon combining unit 21 is displayed on the display screen.

FIG. 3 illustrates an example of the combined icon created by the icon combining unit 21. Referring to FIG. 3, the combined icon 23 is an icon created by combining a plurality of icons by the icon combining unit 21. The combined icon 23, which is created by combining the plurality of icons, allows a plurality of applications to start with a single operation, in this embodiment, with a single click.

Specifically, the combined icon 23 is configured as follows. The combined icon 23 includes a first region 24a, a second region 24b, which is different from the first region 24a, and a third region 24c, which is different from the first region 24a and second region 24b. The first region 24a has a label “X” 25a at the center, denoting that clicking the “X” starts a first application X. The second region 24b has a label “Y” 25b at the center, denoting that clicking the “Y” starts a second application Y. The regions 24a to 24c are partitioned with lines. Each of the first to third regions 24a to 24c is in the shape of a rectangle. The third region 24c is located between the first region 24a and second region 24b. In order to provide a clear understanding, different hatch patterns are applied to the regions 24a to 24c to distinguish them from one another. The regions 24a to 24c can be distinguished by, for example, colors or gradations. These techniques to distinguish the regions can be also applied to the following icons.

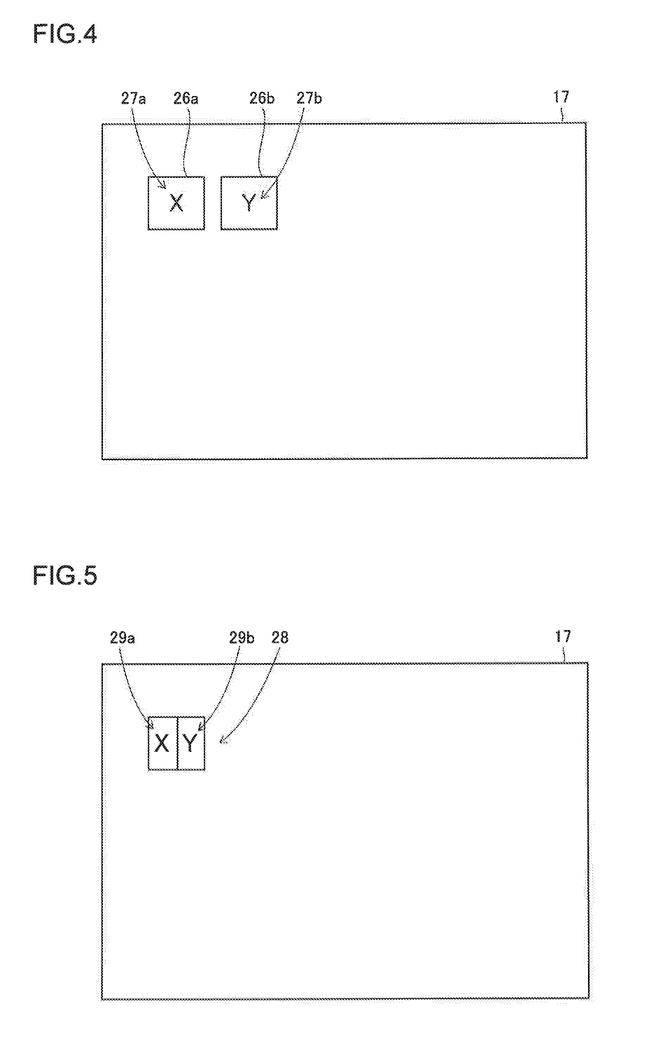

The combined icon 23 is created by, for example, combining a first icon 26a, which has a label “X” 27a and allows the first application X to start with a click, and a second icon 26b, which has a label “Y” 27b and allows the second application Y to start with a click, as shown in FIG. 4. In short, the icon combining unit 21 combines the first icon 26a with the second icon 26b to create the combined icon 23.

The user can start the first application X by clicking the first region 24a of the combined icon 23. In addition, the user can start the second application Y by clicking the second region 24b of the combined icon 23. Furthermore, the user can start both the first and second applications X and Y by clicking the third region 24c of the combined icon 23. Thus, clicking the third region 24c of the combined icon 23 allows the user to start both the first and second applications X and Y at the same time with a single pressing operation.

According to the display control device 13 as configured above, clicking the combined icon 23, or more specifically clicking the third region 24c can start the applications X, Y installed in the computer 12. This eliminates the necessity of pressing a plurality of icons to start the applications X, Y, and therefore reduces the number of the user's operation steps. Thus, the display control device 13 can improve the convenience of users.

In this case, the icon combining unit 21 creates the combined icon 23 that allows the first application X to start with a click on the first region 24a, allows the second application Y to start with a click on the second region 24b, and allows both the first and second applications X, Y to start with a click on the third region 24c. Thus, the applications X, Y can be launched separately by clicking the regions 24a, 24b separately. Therefore, further improvement of the user's convenience can be achieved.

In addition, since the icon combining unit 21 forms the third region 24c between the first region 24a and second region 24b, the user can easily recognize the region 24c to be clicked to start both the applications X, Y. Therefore, still further improvement of the user's convenience can be achieved.

In the above-described embodiment, the combined icon may not be partitioned into the regions 24a to 24c, but can be configured to start both the applications X, Y when just clicked.

FIG. 5 illustrates an example of the combined icon created by the icon combining unit 21 in the above case. Referring to FIG. 5, a combined icon 28 has a label “X” 29a denoting the launch of an application X, and a label “Y” 29b denoting the launch of an application Y. Clicking the combined icon 28 can start both the applications X, Y. In this case, both the applications X, Y are configured to start up with a click on any of the regions of the combined icon 28. The combined icon can be configured as described above.

The combined icons 23, 28 in the above-described embodiment are configured to make it possible to launch two applications X and Y; however, the present disclosure is not limited thereto, but the icon combining unit 21 can be configured to create a combined icon that can start three or more applications.

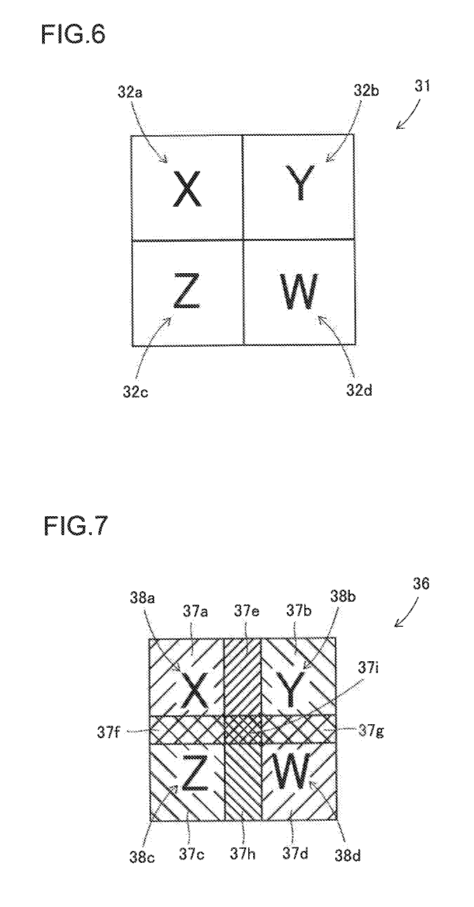

FIG. 6 illustrates an example of the combined icon created by the icon combining unit 21 in the above case. Referring to FIG. 6, a combined icon 31 has a label “X” 32a denoting the launch of an application X, a label “Y” 32b denoting the launch of an application Y, a label “Z” 32c denoting the launch of an application Z, and a label “W” 32d denoting the launch of an application W. All four applications X, Y, Z, W are configured to start up at once with a click on any of the regions of the combined icon 31.

In the above-described embodiment, the combined icon 31 can be configured to start the four applications X, Y, Z, W at once, as well as it can be configured to selectively start, for example, two applications of the four.

FIG. 7 illustrates an example of the combined icon created by the icon combining unit 21 in the above case. Referring to FIG. 7, a combined icon 36 has a label “X” 38a in a region 37a denoting the launch of an application X, a label “Y” 38b in a region 37b denoting the launch of an application Y, a label “Z” 38c in a region 37c denoting the launch of an application Z, and a label “W” 38d in a region 37d denoting the launch of an application W.

In addition, the combined icon 36 has a region 37e, which allows both the application X and application Y to start with a click, provided between the region 37a and region 37b. Similarly, a region 37f that allows both the applications Y and Z to start with a click, a region 37g that allows both the applications Y and W to start with a click, and a region 37h that allows both the applications Z and W to start with a click are provided between the regions 37a and 37c, between the regions 37b and 37d, and between the regions 37c and 37d, respectively. Furthermore, clicking a region 37i located at the center with respect to the regions 37a to 37h can start up the four applications X, Y, Z, W at once. The combined icon can be configured as described above.

The display control unit 22 can be configured to perform control operations to display the applications to be started along with a specified operation, for example, placement of a cursor on the combined icon. This configuration allows the user to recognize in advance which applications are ready to start, thereby improving the user's convenience. It is also possible to configure the applications to start up with a double-click, and to indicate applications that start up with just a single-click as a specified operation.

In the above-described embodiment, the display control unit 22 can be configured to perform control operations so that launchable applications arranged in order are displayed when a specified operation is made, for example, when a cursor is brought over the combined icon, and the user selects an application or applications to be launched.

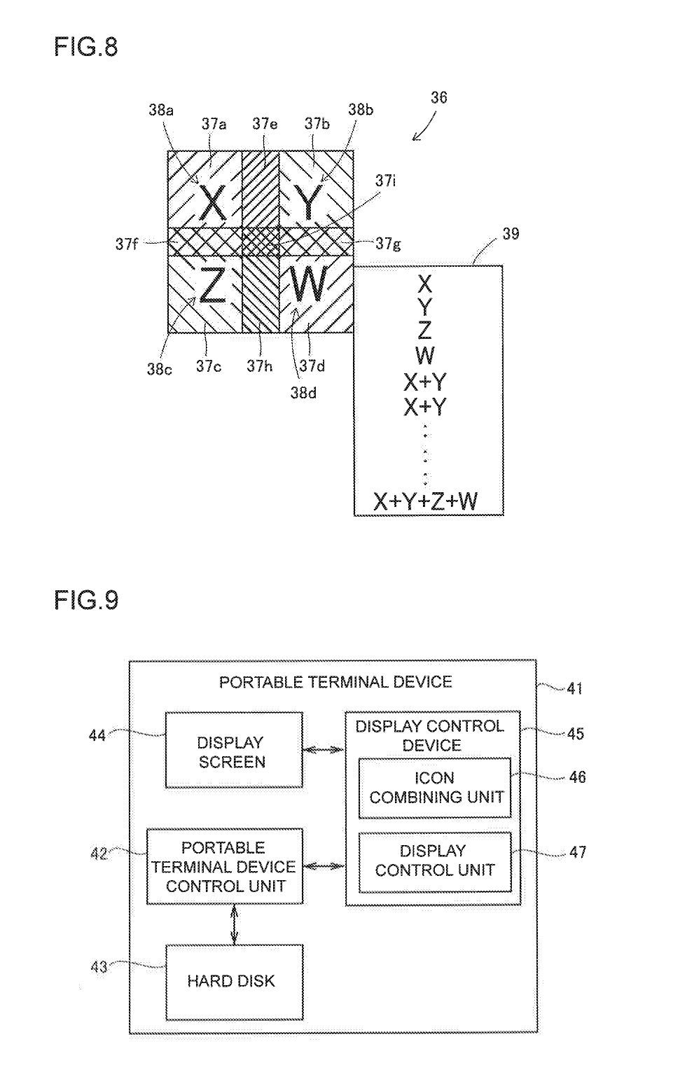

FIG. 8 illustrates an example of the combined icon created by the icon combining unit 21 in the above case. Referring to FIG. 8, when a specified operation is performed on the combined icon 36 shown in FIG. 7, or more specifically when a cursor (not shown) is brought over the combined icon 36, launchable applications, in this case, applications X, Y, Z, W and their possible combinations appear in order in a label 39. When the user intends to start two or more applications from the applications X, Y, Z, W, this configuration allows the user to start up applications more appropriately according to the needs of the user.

In addition, the display control device 13 and other associated components can be used not only to control the display of the display screen 17 of the display 14 connected to the computer 12, but also to control the display of portable terminal devices, such as a smartphone, which are electronic equipment.

FIG. 9 is a block diagram showing the configuration of a portable terminal device including the display control device according to the disclosure. Referring to FIG. 9, a portable terminal device 41 includes a portable terminal device control unit 42, a hard disk 43 serving as a storage unit, a display screen 44, and a display control device 45. The portable terminal device control unit 42 is composed of a control circuit, such as a central processing unit (CPU), and controls the portable terminal device 41 itself. The hard disk 43 stores data. The display screen 44 displays information. Icons and some other pictograms are displayed on the display screen 44. The portable terminal device control unit 42 executes control programs stored in the hard disk 43 to control the operations of components of the portable terminal device 41.

The display control device 45 performs control operations so that an icon that starts an application, which has been installed in the portable terminal device 41 as electronic equipment, is displayed with a specified operation, such as a tap and a flick, on the display screen 44.

The display control device 45 includes an icon combining unit 46 and a display control unit 47. The icon combining unit 46 combines a plurality of icons into a combined icon that allows a plurality of applications to start with a single click. The display control unit 47 performs control operations so that the combined icon, which is created by the icon combining unit 46, is displayed on the display screen. The display control device configured as above can provide more convenience to the user.

It should be understood that the embodiment and examples disclosed herein are illustrative and non-restrictive in every respect. The scope of the present disclosure is defined by the terms of the claims, rather than by the foregoing description, and is intended to include any modifications within the scope and meaning equivalent to the terms of the claims.

The display control device according to the present disclosure can be effectively used especially to meet a demand for improving user convenience.

What is claimed is:

1. A display control device performing control operations to display on a display screen an icon that starts an application installed in electronic equipment, comprising:
an icon combining unit that combines a plurality of icons to create a combined icon allowing a plurality of applications to start with a single operation; and
a display control unit that performs control operations so that the combined icon created by the icon combining unit is displayed on the display screen.

2. The display control device according to claim 1, wherein
the icon combining unit creates the combined icon including a first region that can start a first application when pressed, a second region that can start a second application when pressed, the second region being different from the first region, and the second application being different from the first application, and a third region that can start both the first application and the second application when pressed, the third region being different from the first region and the second region.

3. The display control device according to claim 2, wherein
the icon combining unit forms the third region between the first region and the second region.

4. The display control device according to claim 1, wherein
the display control unit performs control operations to display the applications to be started with a specified operation performed on the combined icon.

5. The display control device according to claim 4, wherein
the display control unit performs control operations so that the applications, capable of being started, are displayed in order when the specified operation is performed on the combined icon, and a user selects an application or applications to be started from the displayed applications.
